(19) United States
(12) Patent Application Publication
(10) Pub. No.: US 2006/0133350 A1
(43) Pub. Date: Jun. 22, 2006

(54) System and method for inter-working centrex with a managed VoIP provider

(76) Inventors: Robert P. Lowmaster, Bartlett, IL (US); Douglas E. Marshall, Round Lake, IL (US)

Correspondence Address: BROOKS KUSHMAN P.C., 1000 TOWN CENTER, TWENTY-SECOND FLOOR, SOUTHFIELD, MI, 48075, US

(21) Appl. No.: 11/020,800

(22) Filed: Dec. 22, 2004

(51) Int. Cl. H04L 12/66

(52) U.S. Cl. 370/352

(57) ABSTRACT

A system for telephone service includes a Centrex served location and a voice over Internet protocol (VoIP) provider served location electrically coupled to the Centrex served location using an IP network. The Centrex served location has an end point from the VoIP provider served location, and users of the system call endpoints at the Centrex served location and endpoints at the VoIP provider served location using abbreviated dialing without incurring local or toll usage charges.

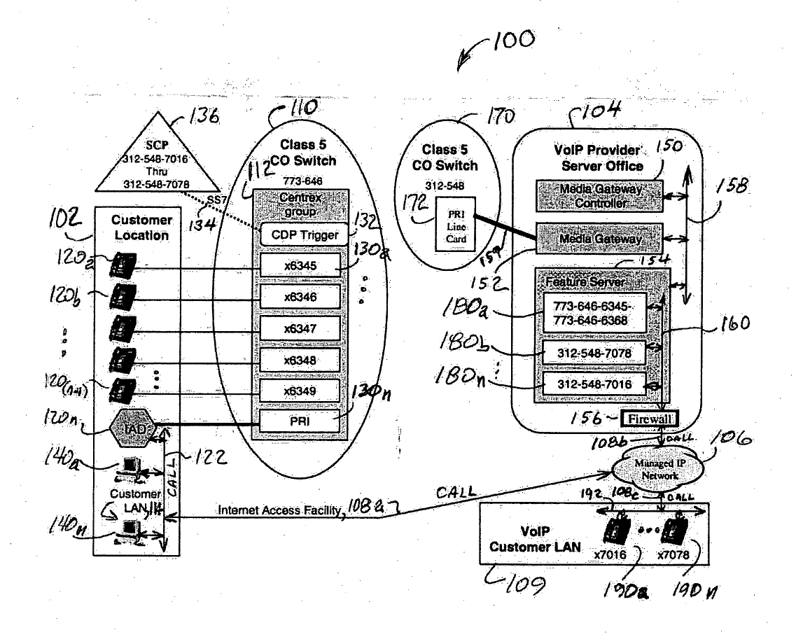

### BACKGROUND OF THE INVENTION

1. Field of the Invention

The present invention relates to a system and method for inter-working Centrex with a managed voice over Internet provider (VoIP).

2. Background Art

Abbreviated dialing techniques (e.g., four digit dialing) are implemented by some telephone users (e.g., business entities, customers, clients, etc.) to simplify and speed up dialing tasks, ease user memory tasks, etc. Some multi-location customers who have one or more locations that are served by a managed Voice over Internet Protocol (VoIP) provider (e.g., Hosted Internet Protocol Communications Service (HIPCS)) may want to have the VoIP served locations interwork with Centrex (which typically includes abbreviated dialing techniques) served locations that are not served by a VoIP provider such that abbreviated dialing between the locations can be implemented for all business entity locations.

However, conventional approaches fail to provide the interwork of the Centrex served locations and VoIP served locations such that HIPCS end users can call Centrex endpoints using abbreviated dialing techniques (e.g., four digit dialing), and vice versa, without incurring local or toll usage charges.

Thus, there exists a need for an improved system and an improved method for interworking centrex with a managed VoIP provider. Such an improved system and an improved method may address some or all of the problems and deficiencies of conventional approaches identified above, and provide additional features and advantages as discussed below.

### BRIEF DESCRIPTION OF THE DRAWINGS

The present invention is pointed out with particularity in the appended claims. However, other features of the present invention will become more apparent, and the present invention will be best understood by referring to the following detailed description in conjunction with the accompanying drawings in which:

The FIGURE illustrates a multi-location telecommunications system of the present invention.

### DETAILED DESCRIPTION OF THE PREFERRED EMBODIMENT(S)

With reference to the Figure, the preferred embodiments of the present invention will now be described in detail. In one example, the present invention may be implemented in connection with a telecommunications transmission and reception system having Centrex served locations and Voice over Internet Protocol provider (VoIP) served locations.

In the description below, the abbreviations, acronyms, terms, etc. may be defined as follows:

AIN: Advanced Intelligence Network. An AIN is a network architecture that uses distributed intelligence in centralized databases to control processing and manage network information, rather than performing the processing and network information managing at every switch in the network. Access to AIN databases provides telecommunications carriers access to the various, appropriate call related databases. AIN information is obtained by performing queries that are routed using a Signal System 7 (SS7) network to the respective Service Control Points (SCPs). ATM: Asynchronous Transfer Mode. ATM is a network technology based on transferring data in cells or packets of a fixed size. The cell used with ATM is relatively small compared to units used with older technologies. The small, constant cell size allows ATM equipment to transmit video, audio, and computer data over the same network, and assure that no single type of data hogs the line. ATM is a dedicated-connection switching technology that organizes digital data into predetermine byte-size cell units and transmits the cell units over a physical medium using digital signal technology. Individually, cells are processed asynchronously relative to other related cells and are queued before being multiplexed over the transmission path.

Centrex: Central office exchange service, a type of PBX service in which switching occurs at a local telephone station instead of at the customer premises. Typically, the telephone company owns and manages all the communications equipment necessary to implement the PBX and then sells various services to the customer.

Class 5 Switch: Central office (CO), or Class 5, switches provide telecommunication services—from basic dial-tone to advanced voice services and data network access—to subscribers within a defined locality or local loop. Service providers are enhancing or replacing traditional Class 5 CO switches with equipment for high-speed data transmission and with support for emerging services such as voice over packet. Internet Data Transfer (IDT, e.g., software) products address CO requirements for reliable, carrier-class equipment that eases the transition from legacy to next-generation networking.

CLEC: Competitive Local Exchange Carrier. A CLEC is a telephone company that competes with an incumbent local exchange carrier (ILEC) such as a Regional Bell Operating Company (RBOC), GTE, ALLNET, etc. With the passage of the Telecommunications Act of 1996, there has been an explosion in the number of CLECs. The Act allows companies with CLEC status to use ILEC infrastructure in two ways:

1) Access to UNEs

Important to CLEC telecommunications networking is the availability of unbundled network elements or UNEs (through a collocation arrangement). UNEs are defined by the Act as any “facility or equipment used in the provision of a telecommunications service,” as well as “features, functions, and capabilities that are provided by means of such facility or equipment.” For CLECs the most important UNE available to them is the local loop, which connects the ILEC switches to the ILEC's present customers. With the local loop, CLECs will be able to connect their switches with the ILEC's switches, thus giving them access to ILEC customers.

2) Resale

Another option open to CLECs is the resale strategy. The Act states that any telecommunications services ILECs offer at retail, must be offered to CLECs at a wholesale discount. This saves the CLEC from having to invest in switches, fiber optic transmission facilities, or collocation arrangements.

In any case, a CLEC may decide on one or the other or even both. CLEC status is very beneficial, especially for ISPs, who may easily get access to the copper loops and other switching elements necessary to provide xDSL services.

CO: Central Office. In telephony, a CO is a telecommunications office centralized in a specific locality to handle the telephone service for that locality. Telephone lines are connected to the CO on a local loop. The CO switches calls between local service and long-distance service. ISDN and DSL signals also channel through the CO.

CPE: Customer premises equipment. Communications equipment that resides on the customer's premises.

Dedicated: Reserved for a specific use. In communications, a dedicated channel is a line reserved exclusively for one type of communication, generally as a leased line or private line.

A dedicated server is a single computer in a network reserved for serving the needs of the network. For example, some networks require that one computer be set aside to manage communications between all the other computers. A dedicated server could also be a computer that manages printer resources. Note, however, that not all servers are dedicated. In some networks, it is possible for a computer to act as a server and perform other functions as well.

The opposite of dedicated is general purpose.

DIA: Dedicated Internet Access. Unlike a dial-up connection, dedicated Internet access means an ‘always-on’ connection that provides maximum speeds and reliability. DIA service is also referred to as broadband and includes categories such as T1 lines, ISDN and DSL.

Firewall: A system designed to prevent unauthorized access to or from a private network. Firewalls can be implemented in both hardware and software, or a combination of both. Firewalls are frequently used to prevent unauthorized Internet users from accessing private networks connected to the Internet, especially intranets. All messages entering or leaving the intranet pass through the firewall, which examines each message and blocks the messages that do not meet the specified security criteria.

There are several types of firewall techniques:

a) Packet filter: Looks at each packet entering or leaving the network and accepts or rejects it based on user-defined rules. Packet filtering is fairly effective and transparent to users, but it is difficult to configure. In addition, packet filtering is susceptible to IP spoofing.

b) Application gateway: Applies security mechanisms to specific applications, such as FTP and Telnet servers. An application gateway is very effective, but can impose a performance degradation.

c) Circuit-level gateway: Applies security mechanisms when a TCP or UDP connection is established. Once the connection has been made, packets can flow between the hosts without further checking.

Proxy server: Intercepts all messages entering and leaving the network. The proxy server effectively hides the true network addresses.

In practice, many firewalls use two or more of these techniques in concert. A firewall is considered a first line of defense in protecting private information. For enhanced security, data can be encrypted.

FTP: File Transfer Protocol. FTP is the protocol for exchanging files over the Internet. FTP works in the same way as HTTP for transferring Web pages from a server to a user's browser and SMTP for transferring electronic mail across the Internet in that, like these technologies, FTP uses the Internet's TCP/IP protocols to enable data transfer. FTP is most commonly used to download a file from a server using the Internet or to upload a file to a server (e.g;, uploading a Web page file to a server).

Gateway:

(1) A node on a network that serves as an entrance to another network. In enterprises, the gateway is the computer that routes the traffic from a workstation to the outside network that is serving the Web pages. In homes, the gateway is the ISP that connects the user to the internet.

In enterprises, the gateway node often acts as a proxy server and a firewall. The gateway is also associated with both a router, which use headers and forwarding tables to determine where packets are sent, and a switch, which provides the actual path for the packet in and out of the gateway.

(2) A computer system located on earth that switches data signals and voice signals between satellites and terrestrial networks.

(3) An earlier term for router, though now obsolete in this sense as router is commonly used.

Further, on the Internet, a node or stopping point can be either a gateway node or a host (end-point) node. Both the computers of Internet users and the computers that serve pages to users are host nodes. The computers that control traffic within a company's network or at a local Internet service provider (ISP) are gateway nodes. In the network for an enterprise, a computer server acting as a gateway node is often also acting as a proxy server and a firewall server. A gateway is often associated with both a router, which knows where to direct a given packet of data that arrives at the gateway, and a switch, which furnishes the actual path in and out of the gateway for a given packet.

HTTP: HyperText Transfer Protocol. HTTP is the underlying protocol used by the World Wide Web. HTTP defines how messages are formatted and transmitted, and what actions Web servers and browsers should take in response to various commands. For example, when you enter a URL in your browser, this actually sends an HTTP command to the Web server directing it to fetch and transmit the requested Web page.

IAD: Integrated Access Device. An IAD is a device that combines multiple end-user services supporting voice, data and video over a single, high-capacity circuit.

ILEC: Incumbent Local Exchange Carrier. An ILEC is a telephone company that was providing local service when the Telecommunications Act of 1996 was enacted. In contrast, a competitive local exchange carrier (CLEC) is a company that competes with the already established ILEC.

Internetworking: The art and science of connecting individual local-area networks (LANs) to create wide-area networks (WANs), and connecting WANs to form even larger WANs. Internetworking can be extremely complex because it generally involves connecting networks that use different protocols. Internetworking is accomplished with routers, bridges, and gateways.

IP: Internet Protocol. IP specifies the format of packets, also called datagrams, and the addressing scheme. Most networks combine IP with a higher-level protocol called Transmission Control Protocol (TCP), collectively, TCP/IP, which establishes a virtual connection between a destination and a source.

ISDN: Integrated services digital network. ISDN is an international communications standard for sending voice, video, and data over digital telephone lines or normal telephone wires. ISDN supports data transfer rates of 64 Kbps (64,000 bits per second).

ISP: Internet Service Provider (also called Internet Access Provider, IAP). An ISP is a company that provides access to the Internet. For a fee, the service provider gives the user a software package, username, password and access phone number. Equipped with a modem, the user logs on to the Internet and browses the World Wide Web and USENET, and sends and receives e-mail.

In addition to serving individuals, ISPs also serve large companies, providing a direct connection from the company's networks to the Internet. ISPs themselves are connected to one another through Network Access Points (NAPs).

IXC: Interexchange Carrier. An IXC is a telephone company that provides connections between local exchanges in different geographic areas. Outlined in the Telecommunications Act of 1996, IXCs provide interLATA service. Well-known IXCs include AT&T, Sprint and MCI.

Media: Plural of medium. (1) Objects on which data can be stored. These include hard disks, floppy disks, CD-ROMs, and tapes. (2) In computer networks, media refers to the cables linking workstations together. There are many different types of transmission media, the most popular being twisted-pair wire (normal electrical wire), coaxial cable (the type of cable used for cable television), and fiber optic cable (cables made out of glass). (3) The form and technology used to communicate information. Multimedia presentations, for example, combine sound, pictures, and videos, all of which are different types of media.

Media Gateway: A media gateway is a network element that provides conversion between the audio signals carried on telephone circuits and data packets carried over the Internet or over other packet networks.

NAP: Network Access Point. A NAP is a public network exchange facility where Internet Service Providers (ISPs) can connect with one another in peering arrangements. The NAPs are a key component of the Internet backbone because the connections within them determine how traffic is routed.

Network: A group of two or more computer systems linked together. Computers on a network are sometimes called nodes. Computers and devices that allocate resources for a network are called servers. There are many types of computer networks, including:

a) local-area networks (LANS): The computers are geographically close together (that is, in the same building).

b) wide-area networks (WANs): The computers are farther apart and are connected by telephone lines or radio waves.

c) campus-area networks (CANs): The computers are within a limited geographic area, such as a campus or military base.

d) metropolitan-area networks MANs): A data network designed for a town or city. home-area networks (HANs): A network contained within a user's home that connects a person's digital devices.

In addition to these types of computer networks, the following characteristics are also used to categorize different types of networks:

i) topology: The geometric arrangement of a computer system. Common topologies include a bus, star, and ring.

ii) protocol: The protocol defines a common set of rules and signals that computers on the network use to communicate. One of the most popular protocols for LANs is called Ethernet. Another popular LAN protocol for PCs is the IBM token-ring network .

iii) architecture: Networks can be broadly classified as using either a peer-to-peer or client/server architecture.

OSI: Open System Interconnection. A networking framework for implementing protocols defined by a seven (7) layer model. Control is passed from one layer to the next, starting at the application layer in one station, proceeding to the bottom layer, over the channel to the next station and back up the hierarchy.

Application Layer (Layer 7): This layer (Layer 7) supports application and end-user processes. Communication partners are identified, quality of service is identified, user authentication and privacy are considered, and any constraints on data syntax are identified. Everything at layer 7 is application-specific. Layer 7 provides application services for file transfers, e-mail, and other network software services. Telnet and FTP are applications that exist entirely in the application level. Tiered application architectures are part of this layer (Layer 7).

Presentation Layer (Layer 6): This layer (Layer 6) provides independence from differences in data representation (e.g., encryption) by translating from application to network format, and vice versa. The presentation layer (Layer 6) works to transform data into the form that the application layer can accept. Layer 6 formats and encrypts data to be sent across a network, providing freedom from compatibility problems. Layer 6 is sometimes called the syntax layer.

Session Layer (Layer 5): This layer (Layer 5) establishes, manages and terminates connections between applications. The session layer sets up, coordinates, and terminates conversations, exchanges, and dialogues between the applications at each end. Layer 5 deals with session and connection coordination.

Transport Layer (Layer 4): This layer (Layer 4) provides transparent transfer of data between end systems, or hosts, and is responsible for end-to-end error recovery and flow control. Layer 4 ensures complete data transfer.

Network Layer (Layer 3): This layer (Layer 3) provides switching and routing technologies, creating logical paths, known as virtual circuits, for transmitting data from node to node. Routing and forwarding are functions of layer 3, as well as addressing, internetworking, error handling, congestion control and packet sequencing.

Data Link Layer (Layer 2): At this layer (Layer 2), data packets are encoded and decoded into bits. Layer 2 furnishes transmission protocol knowledge and management and handles errors in the physical layer, flow control and frame synchronization. The data link layer (Layer 2) is divided into two sublayers: The Media Access Control (MAC) layer and the Logical Link Control (LLC) layer. The MAC sublayer controls how a computer on the network gains access to the data and permission to transmit it. The LLC layer controls frame synchronization, flow control and error checking.

Physical Layer (Layer 1): This layer (Layer 1) conveys the bit stream—electrical impulse, light or radio signal—through the network at the electrical and mechanical level. Layer 1 provides the hardware means of sending and receiving data on a carrier, including defining cables, cards and physical aspects. Fast Ethernet, RS232, and ATM are protocols with physical layer components.

Packet: A piece of a message transmitted over a packet-switching network. One of the key features of a packet is that it contains the destination address in addition to the data. In IP networks, packets are often called datagrams.

Packet switching: Protocols in which messages are divided into packets before they are sent. Each packet is then transmitted individually and can even follow different routes to its destination. Once all the packets forming a message arrive at the destination, the packets are recompiled into the original message.

Most modern Wide Area Network (WAN) protocols, including TCP/IP, X.25, and Frame Relay, are based on packet-switching technologies. In contrast, normal telephone service is based on a circuit-switching technology, in which a dedicated line is allocated for transmission between two parties. Circuit-switching is ideal when data must be transmitted quickly and must arrive in the same order in which the data is sent. This is the case with most real-time data, such as live audio and video. Packet switching is more efficient and robust for data that can withstand some delays in transmission, such as e-mail messages and Web pages. ATM attempts to combine the best of both worlds—the guaranteed delivery of circuit-switched networks and the robustness and efficiency of packet-switching networks.

PBX: Private branch exchange, a private telephone network used within an enterprise. Users of the PBX share a certain number of outside lines for making telephone calls external to the PBX.

Most medium-sized and larger companies use a PBX because a PBX can be much less expensive than connecting an external telephone line to every telephone in the organization. In addition, it is easier to call someone within a PBX because the number that is dialed is typically just 3 or 4 digits.

PIC: Predesignated Interexchange Carrier (telephony); Primary Interexchange Carrier (telephone long distance carrier).

PRI: Primary-Rate Interface. PRI is a type of ISDN service designed for larger organizations. PRI includes 23 B-channels (30 in Europe) and one D-Channel. In contrast, BRI (Basic-Rate Interface), which is designed for individuals and small businesses, contains just two B-channels and one D-channel. PRI service is generally transmitted through a T-1 line (or an E1 line in Europe).

PSTN: Public Switched Telephone Network. PSTN is the world's collection of interconnected voice-oriented public telephone networks, both commercial and government-owned. PSTN is also referred to as the Plain Old Telephone Service (POTS). PSTN is the aggregation of circuit-switching telephone networks that has evolved from the days of Alexander Graham Bell. Today, PSTN is almost entirely digital in technology except for the final link from the central (local) telephone office to the user.

In relation to the Internet, the PSTN actually furnishes much of the Internet's long-distance infrastructure. Because Internet service providers (ISPs) pay the long-distance providers for access to the PSTN infrastructure and share the circuits among many users through packet-switching, Internet users avoid having to pay usage tolls to anyone other than their ISPs.

SCP: Service Control Point (or Signal Control Point). An SCP is a database residing in the SS7 network which is queried to determine how a call should be handled. For instance, an SCP is consulted to provide the translation of an 800 number to an actual phone number and to bill the owner of the 800 number for the call.

SMTP: Simple Mail Transfer Protocol. SMTP is a protocol for sending e-mail messages between servers. Most e-mail systems that send mail over the Internet use SMTP to send messages from one server to another; the messages can then be retrieved with an e-mail client using either POP or IMAP. In addition, SMTP is generally used to send messages from a mail client to a mail server.

SS7: Signaling System 7. SS7 is a telecommunications protocol defined by the International Telecommunication Union (ITU) as a way to offload PSTN data traffic congestion onto a wireless or wireline digital broadband network. SS7 is characterized by high-speed circuit switching and out-of-band signaling using Service Switching (SSPs), Signal Transfer Points (STPs), and Service Control Points (SCPs) (collectively referred to as signaling points, or SS7 nodes). Out-of-band signaling is signaling that does not take place over the same path as the data transfer (or conversation)—a separate digital channel is created (called a signaling link), where messages are exchanged between network elements at 56 or 64 kilobit per second.

SS7 architecture is set up in a way so that any node could exchange signaling with any other SS7-capable node, not just signaling between switches that are directly connected. The SS7 network and protocol are used for:

basic call setup, management, and tear down,

wireless services such as personal communications services (PCS), wireless roaming, and mobile subscriber authentication,

local number portability (LNP),

toll-free (800/888) and toll (900) wireline services,

enhanced call features such as call forwarding, calling party name/number display, and three-way calling, and

efficient and secure worldwide telecommunications.

Switch: In a telecommunications network, a switch is a device that channels incoming data from any of multiple input ports to the specific output port that will take the data toward its intended destination. In the traditional circuit-switched telephone network, one or more switches are used to set up a dedicated though temporary connection or circuit for an exchange between two or more parties. On an Ethernet local area network (LAN), a switch determines from the physical device (Media Access Control or MAC) address in each incoming message frame which output port to forward it to and out of. In a wide area packet-switched network such as the Internet, a switch determines from the IP address in each packet which output port to use for the next part of its trip to the intended destination.

In the Open Systems Interconnection (OSI) communications model, a switch performs the layer 2 or Data-Link layer function. That is, the switch simply looks at each packet or data unit and determines from a physical address (the “MAC address”) which device a data unit is intended for and switches the data unit out toward that device. However, in wide area networks such as the Internet, the destination address requires a look-up in a routing table by a device known as a router. Some newer switches also perform routing functions (layer 3 or the Network layer functions in OSI) and are sometimes called IP switches.

On larger networks, the trip from one switch point to another in the network is called a hop. The time a switch takes to figure out where to forward a data unit is called its latency. The price paid for having the flexibility that switches provide in a network is this latency. Switches are found at the backbone and gateway levels of a network where one network connects with another and at the subnetwork level where data is being forwarded close to the respective destination or origin. The former are often known as core switches and the latter as desktop switches.

In the simplest networks, a switch is not required for messages that are sent and received within the network. For example, a local area network may be organized in a token ring or bus arrangement in which each possible destination inspects each message and reads any message with the respective address.

T-1 carrier: A dedicated phone connection supporting data rates of 1.544 Mbits per second. A T-1 line actually consists of 24 individual channels, each of which supports 64 Kbits per second. Each 64 Kbit/second channel can be configured to carry voice or data traffic. Most telephone companies allow a user to buy just some of these individual channels, known as fractional T-1 access.

T-1 lines are a popular leased line option for businesses connecting to the Internet and for Internet Service Providers (ISPs) connecting to the Internet backbone. The Internet backbone itself consists of faster T-3 connections. T-1 lines are sometimes referred to as DS1 lines.

TCP: Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent.

TDM: Time Division Multiplexing. TDM is a type of multiplexing that combines data streams by assigning each stream a different time slot in a set. TDM repeatedly transmits a fixed sequence of time slots over a single transmission channel. Within T-Carrier systems, such as T-1 and T-3, TDM combines Pulse Code Modulated (PCM) streams created for each conversation or data stream. TDM is a method of putting multiple data streams in a single signal by separating the signal into many segments, each having a very short duration. Each individual data stream is reassembled at the receiving end based on the timing.

The circuit that combines signals at the source (transmitting) end of a communications link is known as a multiplexer (or mux). The multiplexer accepts the input (i.e., signals) from each individual end user, breaks each signal into segments, and assigns the segments to the composite signal in a rotating, repeating sequence. The composite signal thus contains data from multiple senders. At the other end of the long-distance cable, the individual signals are separated out by means of a circuit called a demultiplexer, and routed to the proper end users. A two-way communications circuit requires a multiplexer/demultiplexer at each end of the long-distance, high-bandwidth cable.

Telnet: A terminal emulation program for TCP/IP networks such as the Internet. The Telnet program runs on a user computer and connects the user PC to a server on the network. The user can then enter commands through the Telnet program and the commands will be executed as if the user were entering the commands directly on the server console. The Telnet enables the user to control the server and communicate with other servers on the network. To start a Telnet session, the user must log in to a server by entering a valid username and password. Telnet is a common way to remotely control Web servers.

UDP: User Datagram Protocol. UDP is a connectionless protocol that, like TCP, runs on top of IP networks. Unlike TCP/IP, UDP/IP provides very few error recovery services, offering instead a direct way to send and receive datagrams over an IP network. UDP is used primarily for broadcasting messages over a network.

UNE: Unbundled Network Element. UNEs are parts of a network that ILECs are required to offer to their customers on an unbundled basis. Important to CLEC telecommunications networking is the availability of UNEs (through a collocation arrangement). UNEs are defined by the Telecommunications Act of 1996 as any “facility or equipment used in the provision of a telecommunications service,” as well as “features, functions, and capabilities that are provided by means of such facility or equipment.” For CLECs the most important UNE available to them is the local loop, which connects the ILEC switches to the ILEC's present customers. With the local loop, CLECs will be able to connect their switches with the ILEC's switches, thus giving the CLECs access to ILEC customers.

VoIP: Voice over Internet Protocol. VoIP is a category of hardware and software that enables people to use the Internet as the transmission medium for telephone calls by sending voice data in packets using Internet Protocol (IP) rather than by traditional circuit transmissions of the public switched telephone network (PSTN). One advantage of VoIP is that the telephone calls over the Internet do not incur a surcharge beyond what the user is paying for Internet access, much in the same way that the user doesn't pay for sending individual e-mails over the Internet. There are many Internet telephony applications available. Some, such as CoolTalk and NetMeeting, may be provided bundled with popular Web browsers. Others are stand-alone products. VoIP also is referred to as Internet telephony, IP telephony, or Voice over the Internet (VOI).

Further, VoIP is a term used in IP telephony for a set of facilities for managing the delivery of voice information using the IP. In general, this means sending voice information in digital form in discrete packets rather than in the traditional circuit-committed protocols of the PSTN. A major advantage of VoIP and Internet telephony is that it avoids the tolls charged by ordinary telephone service. VoIP, now used somewhat generally, derives from the VoIP Forum, an effort by major equipment providers, including Cisco, VocalTec, 3Com, and Netspeak to promote the use of ITU-T H.323, the standard for sending voice (audio) and video using IP on the public Internet and within an intranet. The Forum also promotes the user of directory service standards so that users can locate other users and the use of touch-tone signals for automatic call distribution and voice mail.

In addition to IP, VoIP uses the real-time protocol (RTP) to help ensure that packets get delivered in a timely way. Using public networks, it is currently difficult to guarantee Quality of Service (QoS). Better service is possible with private networks managed by an enterprise or by an Internet telephony service provider (ITSP). Using VoIP, an enterprise positions a “VoIP device” at a gateway. The gateway receives packetized voice transmissions from users within the company and then routes them to other parts of its intranet (local area or wide area network) or, using a T-carrier system or E-carrier interface, sends them over the public switched telephone network.

VoIP uses the RTP and runs over the User Datagram Protocol (UDP), over IP. The RTP header identifies packets as containing a voice sampling in a particular encoding format. A timestamp and sequence number are used to reassemble a synchronous voice stream from a stream of RTP packets. UDP port numbers are used to multiplex and distinguish multiple call streams between IP endpoints. Compression and call control is facilitated by the ITU's H.323 and related standards for multimedia transmission, or possibly the Session Initiation Protocol and related protocols, developed by the Internet community for simpler client implementation (e.g., for IP phones).

The deployment architecture for VoIP is similar to Voice over ATM (over DSL). An IP-based internet access device capable of supporting compressed voice, data, fax, and modem traffic at a customers premises multiplexes IP voice and data streams onto an IP network, over any broadband access circuit, including any DSL access. Voice traffic is routed to a voice gateway, where, the IP-packetized voice traffic is converted to a digital voice signal and sent to a Class 5 switch, over a standard (e.g., Bellcore GR-303-CORE) digital trunk interface. As is the case for ATM-based deployment, Quality of Service across the entire IP infrastructure between voice users is critical to maintain toll-quality voice. CLECs that support IP and intend or already support differentiated services using IP QoS methods (MPLS, Diffserv) will find VoIP attractive.

xDSL: Refers collectively to all types of digital subscriber lines (DSLs), the two main categories being ADSL and SDSL. Two other types of xDSL technologies are High-data-rate DSL (HDSL) and Very high DSL (VDSL).

DSL technologies use sophisticated modulation schemes to pack data onto copper wires. DSL technologies are sometimes referred to as last-mile technologies because they are used only for connections from a telephone switching station to a home or office, not between switching stations.

xDSL is similar to ISDN inasmuch as both operate over existing copper telephone lines (POTS) and both require the short runs to a central telephone office (usually less than 20,000 feet). However, xDSL offers much higher speeds-up to 32 Mbps for upstream traffic, and from 32 Kbps to over 1 Mbps for downstream traffic.

Some multi-location telecommunications customers (e.g., telephone users, business entities, clients, etc.) have one or more locations that are served by a managed Voice over Internet Protocol (VOIP) provider (e.g., a Hosted Internet Protocol Communications Service (HIPCS)) and other locations that are served by Centrex implementations. Such clients may desire that the respective VoIP served location interwork with the Centrex served locations such that abbreviated dialing techniques (e.g., three digit dialing, four digit dialing, abbreviated last name/first name dialing, etc.) can be used between all of the locations in the telecommunications system.

Abbreviated dialing between Centrex served locations and VoIP served locations may be cost effectively implemented using the improved system and the improved method of the present invention because HIPCS end users are able to call Centrex endpoints using abbreviated dialing, and vice versa, without incurring local or toll usage charges. In contrast, conventional approaches to interworking Centrex served locations and VoIP served locations typically incur local or toll usage charges.

The present invention generally provides an access point from the VoIP provider into (i.e, within, integrated as part of, implemented in connection with, etc.) the Centrex group, and vice versa. The access point from the VoIP provider may be implemented by customer deployment of an Integrated Access Device (IAD) as an endpoint on the Centrex group as a Customer Provided Equipment (CPE) device that is implemented in addition to other CPE devices. The IAD may operate (i.e., serve, perform, etc.) as a customer provided Media Gateway that generally converts analog/TDM voice traffic into IP packetized voice (i.e., VoIP compliant signals).

According to the present invention, a system for telephone service is provided. The system comprises a Centrex served location and a voice over Internet protocol (VoIP) provider served location electrically coupled to the Centrex served location using an IP network. The Centrex served location has an end point from the VoIP provider served location, and users of the system call endpoints at the Centrex served location and endpoints at the VoIP provider served location using abbreviated dialing without incurring local or toll usage charges.

Also according to the present invention, a method for providing telephone service is provided. The method comprises electrically coupling a Centrex served location to a voice over Internet protocol (VOIP) provider served location using an IP network, and terminating an end point from the VoIP provider served location at the Centrex served location. Users of the Centrex served location and the VoIP provider served location call endpoints at the Centrex served location and endpoints at the VoIP provider served location using abbreviated dialing without incurring local or toll usage charges.

Yet further, according to the present invention, a system for telephone service is provided. The system comprises a Centrex served location and a voice over Internet protocol (VoIP) provider served location electrically coupled to the Centrex served location using an IP network. The Centrex served location has an end point from the VoIP provider served location comprising an integrated access device (IAD) implemented as a customer provided equipment (CPE) device that is implemented in addition to other CPE devices in the Centrex served location and that operates as a media gateway that converts analog/time division multiplexing (TDM) voice traffic into Internet protocol (IP) packetized VoIP compliant signals. A Class 5 switch having a primary rate ISDN (PRI) facility is terminated on the IAD. Users of the system call endpoints at the Centrex served location and endpoints at the VoIP provider served location using abbreviated dialing without incurring local or toll usage charges.

Referring to the Figure, a diagram illustrating a telecommunications system 100 of the present invention is shown. The system 100 is generally implemented as a multi-location telecommunications system having telephone users (e.g., business entities, customers, clients, etc.) with telephone service that may be both Centrex served at some user locations and VoIP served at other user locations. The present invention generally provides interworking between the Centrex served locations and the VoIP served locations such that abbreviated dialing techniques (e.g., three digit dialing, four digit dialing, abbreviated last name/first name dialing, etc.) is generally available to all users within the system 100 (e.g., all business entity locations) without incurring local or toll usage charges.

The system 100 generally comprises a Centrex served location (e.g., office, business entity, etc.) 102, a VoIP provider server office 104, and a VoIP customer 109 that are electrically coupled (i.e., interworked or internetworked) together via a managed IP network 106 serially coupled to an Internet access facility 108 (e.g., Internet access facilities 108a, 108b, and 108c). Telephone call signals (e.g., CALL) are generally presented to and received from the Centrex served location 102 and the VoIP customer 109, and vice versa, over (or via) the network 106 and the access facilities 108a and 108b. The signals CALL may be sent between the location 102 and the customer using abbreviated dialing. While only one Centrex served location 102 and only one VoIP customer 109 are illustrated for clarity of explanation, in another example, the system 100 may include more than one Centrex served location 102 and more than one VoIP customer 109.

The customer location 102 generally comprises a Class 5 Central Office (CO) switch 110 that includes a Centrex group 112. The location 102 may further comprise a customer LAN 114.

The location 102 generally comprises a plurality of end points e.g., access points, switch points, ports, nodes, stations, etc.) 120 (e.g., end points 120a-120n) that may be electrically coupled to the access facility 108 via a bus 122. The end points 120 generally comprise a customer provided (or premises) equipment (CPE) device. However, one of the end points (e.g., the end point 120n) may be implemented as an integrated access device (IAD).

Each of the end points 120 generally has a respective (i.e., corresponding) node 130 (e.g., nodes 130a-130n) that is generally implemented in connection with the Centrex group 112 in the Class 5 CO switch 110. The node that corresponds to the access point where the IAD (i.e., the end point 120n) is implemented (e.g., the node 130n) may be implemented as a primary rate interface (PRI). Each end point 112 (and each respective node 130) generally relates to a predetermined telephone number and is generally available for access using abbreviated dialing.

The Centrex group 112 may further include a customized dial plan (CDP) trigger 132. The CDP trigger 132 is generally implemented in connection with a Signaling System 7 (SS7) having a service control point (SCP) 136. The SCP 136 is generally configured to control handing of a predetermined range of telephone numbers that includes the respective telephone numbers for all of the end points 120 (and all of the respective nodes 130).

The LAN 114 generally comprises at least one computer (e.g., personal computer, processor, work station etc.) 140 (e.g., computers 140a-140n) that is electrically coupled to the bus 122. The Internet access facility 108 is generally electrically coupled to the location 102 via the bus 122.

The VoIP served location 104 generally comprises a media gateway controller 150, a media gateway 152, a feature server 154, and a firewall 156. The controller 150, the gateway 152, and the server 154 may be electrically coupled using a bus 158. The server 154 may be electrically coupled to the firewall 156 via a bus 160. The location 104 may be electrically coupled to the network 106 through the firewall 156 over the Internet access facility 108b. The controller 150 may control operations (e.g., processes) of the location 104.

A Class 5 CO switch 170 may be implemented in connection with the gateway 152. The switch 170 generally comprises a primary-rate interface (PRI) line card 172 that may be electrically coupled to the gateway 152 (e.g., via a bus 159).

The server 154 generally comprises a plurality of end points (or nodes) 180 (e.g., nodes 180a-180n) that may be electrically coupled to the bus 160. The nodes 180 may relate to respective predetermined telephone numbers that may be accessed using abbreviated dialing.

The Internet access facilities 108 may be implemented as wiring, cable, fiber optics, wireless, or any other appropriate interconnection system between the location 102, the network 106, the server office 104, and the customer 109. The LAN 109 generally comprises a plurality of CPEs 190 (e.g., CPEs 190a-190n) that may be coupled to the network 106 via a bus 192 over the Internet access facility 108c.

In one example (not shown), the Centrex group 112 interface to the IAD 120n may be implemented as a set of Centrex lines. However, the preferred Centrex 112 interface to the IAD 120n is generally the Primary Rate ISDN (PRI) facility 130n that is implemented as part of the Centrex group 112, and having the PRI 130n terminate on the IAD 120n. The VoIP provider 104 generally uses the managed IP network 106 and the Internet access facilities 108a and 108c to manage the IAD 120n. The IAD 120n generally converts the Centrex calls (e.g., the signal CALL) destined for one of the VoIP served endpoints 180 into VoIP packets, and delivers the VoIP packets CALL to the Internet access facility 108a (and vice versa for VoIP originated calls to a Centrex station 120).

Calls placed between the Centrex group 112 at the location 102 and the VoIP customer 109 service will be on-net VoIP data transmissions that transit over the Internet access service used by the respective customers and across the VoIP provider managed IP network 106 (and, in some examples, over the Internet). The VoIP data transmission (e.g., the signal CALL presented and received via the network 106) is generally part of a respective Internet Service Provider (ISP) information service. Therefore, the Class 5 switch 110 generally regards the calls CALL as Intra-Centrex signals and there is no incremental Incumbent Local Exchange Carrier (ILEC) related charge for the calls CALL.

The Class 5 Switch 110 generally uses the translations 130 built in the Centrex Group 112 to determine that the call should be routed to PRI at 130n, which terminates on the IAD 120n. The call set-up signaling, and subsequent disconnect signaling, is generally sent from the IAD 120n to the VoIP provider 104 across the Internet access facilities 108 and the Managed IP Network 106, which generally uses the translations 180 on the Feature Server 154 to determine that the call is to be connected to the destination 190 at the VoIP customer 109. The VoIP provider Server Office 104 generally sends routing instructions back to the IAD 120n, which sets up the bearer path over the Internet access facilities 108, across the Managed IP Network 106 to the IP telephone 190 at the VoIP Customer Location 109.

The Centrex number range may be built and maintained (i.e., predetermined) on the VoIP provider 104 platform, and the number range used by the VoIP provider served locations (e.g., the nodes 180) may be added to and maintained in the Centrex 112 routing tables (e.g., in connection with the SCP 136). When the number ranges used by the VoIP customer location 109 are numbers that would otherwise be served by the Class 5 switch 110 hosting the Centrex group 112, the numbers can be added to the Class 5 switch 110 routing table with the routing instructions that direct calls placed to the numbers to the IAD 120n via the PRI facility 130n.

When the telephone number ranges are not consistent with the numbers normally served by the Class 5 switch 110, an alternative routing table management may be implemented. In one example alternative, an Advanced Intelligence Network (AIN) functionality may be implemented (e.g., using the CDP AIN trigger 132 in the Class 5 switch 110). Centrex group 112 originated abbreviated dialed calls not recognized by the Class 5 switch 112 as an intra-Centrex call may trigger a query to the SCP 136.

The routing tables that are built on the SCP 136 generally include instructions such that abbreviated dial calls to the respective number in the routing table are routed to the PRI 130n that terminates on the IAD 120n. The SCP 136 may respond to such queries with routing instructions that direct the Class 5 switch 110 to route the call to the PRI 130n terminating on the IAD implemented at the end point 120n. The IAD 120n will generally convert the calls for the location 104 into VoIP packets (e.g., the signal CALL) and send the packets over the Internet access facility 108 to the VoIP provider network 106 for routing and completion (e.g., routing through the firewall and the bus 160 to the respective CPE related to an end point 180).

Utilizing the AIN type of functionality described above, the Centrex group 112 may use abbreviated dialing to the numbers for which the routing tables point to the IAD 120n and reach the desired VoIP 104 endpoint 180. The VoIP endpoint 180 generally receives and is able to display the calling party number (CPN) associated with the respective Centrex customer location 102 caller. Similarly, the VoIP 104 end user may use abbreviated dialing to reach a desired Centrex location 102 number (e.g., a number associated with a CPE 120 and a respective end point 130). The availability of the CPN at the Centrex CPE will generally depend on whether the Class 5 interface 110 to the IAD 120n is a Centex line or the preferred PRI facility 130n. The CPN will be available for display on the Centrex CPE 120 when the PRI facility 130n is used. When Centrex lines are used, the CPN of the Centex line will appear.

In another alternative example, instead of using AIN for the routing table management, when the Class 5 switch 110 that hosts the Centrex group 112 does not serve the VoIP 104 number ranges, the Centrex customer may request that additional numbers be assigned to the Centrex group 112. The requested predetermined telephone numbers may have ending digits that match the ending digits of the VoIP 104 numbers (i.e., numbers that are associated with nodes 180). Centrex calls using abbreviated dialing would route to the IAD 120n using the predetermined matching number for routing. The VoIP provider 104 will generally recognize the appropriate VoIP user based on the delivered CPN (which would be the matching number added to the Centrex group 112) and would complete the call in an appropriate manner (including display of the correct CPN).

In yet another alternative example implementation, the Centrex location 102 may request routing all off-Centrex traffic to the IAD 120n. Such an implementation may result in conversion of the traffic (e.g., signals CALL) that originates at the Centrex 102 to VoIP packets, and sends messages requesting routing instructions to the VoIP provider 104. The VoIP provider 104 platform will generally accept the calls CALL from the IAD 120n and process the signals CALL in the same manner as any other of the VoIP 104 customer calls. On-net VoIP calls will generally complete over the managed IP network 106 (or the Internet, as appropriate), and off-net calls are generally routed to the appropriate VoIP provider Media Gateway 152 for completion to the proper Class 5 switch 170. In this instance, an abbreviated dialed call that is not recognized by the Class 5 switch 170 as part of the Centrex group 112 is generally routed to the IAD 120n for completion or for treatment (e.g., conversion and delivery).

Similarly, the multi-location customer 109 served by the VoIP provider system 104 may request that all off-net traffic (e.g., signals CALL) be routed to the IAD 120n, which generally results in the Class 5 switch 110 serving the Centrex group 112 process the calls as normal Centrex traffic. Generally, off-Centrex traffic originated (from the Centrex 112 perspective) from the end point IAD 120n may be routed to the public switched telephone network (PSTN) using normal Centrex call processing, including the involvement of the respective predesignated interexchange carrier (PIC) or other interexchange carrier (IXC) when appropriate.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for telephone service, the system comprising:
a Centrex served location; and
a voice over Internet protocol (VoIP) provider served location electrically coupled to the Centrex served location using an IP network, wherein the Centrex served location has an end point from the VoIP provider served location, and users of the system call endpoints at the Centrex served location and endpoints at the VoIP provider served location using abbreviated dialing without incurring local or toll usage charges.

2. The system of claim 1, wherein the Centrex served location end point from the VoIP provider served location comprises an integrated access device (IAD) implemented as a customer provided equipment (CPE) device that is implemented in addition to other CPE devices in the Centrex served location.

3. The system of claim 2, wherein the IAD operates as a media gateway that converts analog/time division multiplexing (TDM) voice traffic into Internet protocol (IP) packetized VoIP compliant signals.

4. The system of claim 2 further comprising a Class 5 switch having a primary rate ISDN (PRI) facility terminated on the IAD.

5. The system of claim 4, wherein the calls placed between the Centrex served location and the VoIP provider location are on-net VoIP data transmissions that transit over a customers Internet access service and across the VoIP provider managed IP network as part of an Internet Service Provider (ISP) information service, and the Class 5 switch regards the calls as Intra-Centrex signals and there is no incremental Incumbent Local Exchange Carrier (ILEC) related charge for the calls.

6. The system of claim 2, wherein the IAD is coupled to the IP network via an Internet access facility.

7. The system of claim 4, wherein the Centrex served location further comprises a Signaling System 7 (SS 7) having a service control point (SCP) including routing tables and coupled to a customized dial plan (CDP) trigger having Advanced Intelligence Network (AIN) functionality, and when calls having telephone number ranges that are not consistent with numbers normally served by the Centrex served location are made, a query is triggered to the SCP and the SCP provides instructions to route the calls having telephone number ranges that are not consistent to the PRI facility.

8. The system of claim 4, wherein the Centrex served location further comprises a routing table including predetermined telephone numbers having ending digits that match telephone numbers at the VoIP provider served location.

9. The system of claim 4, wherein the Centrex served location routes all off-Centrex calls to the IAD for at least one of completion, and conversion and delivery.

10. A method for providing telephone service, the method comprising:
electrically coupling a Centrex served location to a voice over Internet protocol (VoIP) provider served location using an IP network; and
terminating an end point from the VoIP provider served location at the Centrex served location, wherein users of the Centrex served location and the VoIP provider served location call endpoints at the Centrex served location and endpoints at the VoIP provider served location using abbreviated dialing without incurring local or toll usage charges.

11. The method of claim 10, wherein the Centrex served location end point from the VoIP provider served location is an integrated access device (IAD) implemented as a customer provided equipment (CPE) device that is implemented in addition to other CPE devices in the Centrex served location.

12. The method of claim 11, wherein the IAD operates as a media gateway that converts analog/time division multiplexing (TDM) voice traffic into Internet protocol (IP) packetized VoIP compliant signals.

13. The method of claim 11, wherein a Class 5 switch having a primary rate ISDN (PRI) facility is terminated on the IAD.

14. The method of claim 13, wherein the calls placed between the Centrex served location and the VoIP provider location are on-net VoIP data transmissions that transit over a customers Internet access service and across the VoIP provider managed IP network as part of an Internet Service Provider (ISP) information service, and the Class 5 switch regards the calls as Intra-Centrex signals and there is no incremental Incumbent Local Exchange Carrier (ILEC) related charge for the calls.

15. The method of claim 11, wherein the IAD is coupled to the IP network via an Internet access facility.

16. The method of claim 13, wherein the Centrex served location further comprises a Signaling System 7 (SS 7) having a service control point (SCP) including routing tables and coupled to a customized dial plan (CDP) trigger having Advanced Intelligence Network (AIN) functionality, and when calls having telephone number ranges that are not consistent with numbers normally served by the Centrex served location are made, a query is triggered to the SCP and the SCP provides instructions to route the calls having telephone number ranges that are not consistent to the PRI facility.

17. The method of claim 13, wherein the Centrex served location further comprises a routing table including predetermined telephone numbers having ending digits that match telephone numbers at the VoIP provider served location.

18. The method of claim 13, wherein the Centrex served location routes all off-Centrex calls to the IAD for at least one of completion, and conversion and delivery.

19. A system for telephone service, the system comprising:
a Centrex served location; and
a voice over Internet protocol (VoIP) provider served location electrically coupled to the Centrex served location using an IP network, wherein the Centrex served location has an end point from the VoIP provider served location comprising an integrated access device (IAD) implemented as a customer provided equipment (CPE) device that is implemented in addition to other CPE devices in the Centrex served location and that operates as a media gateway that converts analog/time division multiplexing (TDM) voice traffic into Internet protocol (IP) packetized VoIP compliant signals, a Class 5 switch having a primary rate ISDN (PRI) facility is terminated on the IAD, and users of the system call endpoints at the Centrex served location and endpoints at the VoIP provider served location using abbreviated dialing without incurring local or toll usage charges.

20. The system of claim 19, wherein the Centrex served location further comprises a Signaling System 7 (SS 7) having a service control point (SCP) including routing tables and coupled to a customized dial plan (CDP) trigger having Advanced Intelligence Network (AIN) functionality, and when calls having telephone number ranges that are not consistent with numbers normally served by the Centrex served location are made, a query is triggered to the SCP and the SCP provides instructions to route the calls having telephone number ranges that are not consistent to the PRI facility.
